(19) United States
(12) Patent Application Publication
(10) Pub. No.: US 2025/0253526 A1
(43) Pub. Date: Aug. 7, 2025

(54) REMOTE ELECTRONIC TILT (RET) ACTUATORS FOR ANTENNAS AND METHODS RELATED TO POSITIONING SAME

(71) Applicant: Outdoor Wireless Networks LLC, Claremont, NC (US)

(72) Inventors: Chih Lin Lin Chou, Allen, TX (US); Deepali A. Limaye, Frisco, TX (US); Paul D. Everest, Flower Mound, TX (US)

(21) Appl. No.: 18/855,695

(22) PCT Filed: Apr. 27, 2023
(86) PCT No.: PCT/US2023/020224

§ 371 Date: Oct. 10, 2024

Related U.S. Application Data
(60) Provisional application No. 63/341,137, filed on May 12, 2022.

(51) Int. Cl. H01Q 3/32; G01D 5/14; H01Q 1/24

(52) U.S. Cl. CPC H01Q 3/32; G01D 5/145; H01Q 1/246

(57) ABSTRACT

The present disclosure is directed to a multi-RET actuator system. The system includes a plurality of drive assemblies operatively connected to one or more phase shifter assemblies such that movement of one of the drive assemblies adjusts at least one, of the one or more phase shifter assemblies; a drive system including a drive screw and a drive shaft, the drive shaft supporting a second connector, the drive system configured to transversely move along the drive screw to position the drive system adjacent to a target drive assembly of the plurality of drive assemblies, a movable sled assembly operatively connected to the drive system, the movable sled assembly configured to extend or retract such that movement of the sled assembly selectively engages or disengages the second connector with a respective first connector for the target drive assembly. Methods of calibrating and operating multi-RET actuator systems are also described herein.

### RELATED APPLICATION(S)

The present application claims priority from and the benefit of U.S. Provisional Patent Application No. 63/341,137, filed May 12, 2022, the disclosure of which is hereby incorporate herein by reference in its entirety.

### FIELD

The present invention relates to communication systems, and in particular, to remote electronic tilt (RET) actuators for antennas and methods for calibrating and positioning same.

### BACKGROUND

Cellular communications systems are used to provide wireless communications to fixed and mobile subscribers. A cellular communications system may include a plurality of base stations that each provide wireless cellular service for a specified coverage area that is typically referred to as a “cell.” Each base station may include one or more base station antennas that are used to transmit radio frequency (“RF”) signals to, and receive RF signals from, the subscribers that are within the cell served by the base station. Base station antennas are directional devices that can concentrate the RF energy that is transmitted in or received from certain directions. The“gain” of a base station antenna in a given direction is a measure of the ability of the antenna to concentrate the RF energy in that direction. The “radiation pattern” of a base station antenna—which is also referred to as an “antenna beam”—is a compilation of the gain of the antenna across all different directions. Each antenna beam may be designed to service a pre-defined coverage area such as the cell or a portion thereof that is referred to as a “sector.” Each antenna beam may be designed to exceed minimum gain levels throughout the pre-defined coverage area, and to have much lower gain levels outside of the coverage area to reduce interference between neighboring cells/sectors. Base station antennas typically comprise linear or planar arrays of radiating elements such as patch, dipole or crossed dipole radiating elements. Many base station antennas now include multiple arrays of radiating elements, each of which generates its own antenna beam.

Early base station antennas generated antenna beams having fixed shapes, meaning that once a base station antenna was installed, its antenna beam(s) could not be changed unless a technician physically reconfigured the antenna. Many modern base station antennas now have antenna beams that can be electronically reconfigured from a remote location. The most common way in which an antenna beam may be reconfigured electronically is to change the pointing direction of the antenna beam (i.e., the direction in which the antenna beam has the highest gain), which is referred to as electronically “steering” the antenna beam. An antenna beam may be steered horizontally in the azimuth plane and/or vertically in the elevation plane. An antenna beam can be electronically steered by transmitting control signals to the antenna that cause the antenna to alter the phases of the sub-components of the RF signals that are transmitted and received by the individual radiating elements of the array that generates the antenna beam. Most modern base station antennas are configured so that the elevation or “tilt” angle of the antenna beams generated by the antenna can be electronically altered. Such antennas are commonly referred to as remote electronic tilt (“RET”) antennas.

In order to electronically change the down tilt angle of an antenna beam generated by a linear array of radiating elements, a phase progression may be applied across the radiating elements of the array. Such a phase progression may be applied by adjusting the settings on a phase shifter that is positioned along the RF transmission path between a radio and the individual radiating elements of the linear array. One widely-used type of phase shifter is an electromechanical “wiper” phaseshifter that includes a main printed circuit board and a “wiper” printed circuit board that may be rotated above the main printed circuit board. Such wiper phase shifters typically divide an inputRF signal that is received at the main printed circuit board into a plurality of sub-components, and then couple at least some of these sub-components to the wiper printed circuit board. The sub-components of the RF signal may be coupled from the wiper printed circuit board back to the main printed circuit board along a plurality of concentric arc-shaped traces, where each arc has a different diameter. Each end of each arc-shaped trace may be connected to a respective sub-group of radiating elements that includes at least one radiating element. By physically (mechanically) rotating the wiper printed circuit board above the main printed circuit board, the locations where the sub-components of the RF signal couple back to the main printed circuit board may be changed, which thus changes the lengths of the transmission paths from the phase shifter to the respective sub-groups of radiating elements. The changes in these path lengths result in changes in the phases of the respective sub-components of the RF signal, and since the arcs have different radii, the phase changes along the different paths will be different. Typically, the phase progression is applied by applying positive phase shifts of various magnitudes (e.g., +X°, +2X° and +3X°) to some of the sub-components of the RF signal and by applying negative phase shifts of the same magnitudes (e.g., −X°, −2X° and −3X°) to additional of the sub-components of the RF signal. Exemplary phase shifters of this variety are discussed in U.S. Pat. No. 7,907,096 to Timofeev, the disclosure of which is hereby incorporated herein in its entirety. The wiper printed circuit board is typically moved using an electromechanical actuator such as a DC motor that is connected to the wiper printed circuit board via a mechanical linkage. These actuators are often referred to as “RET actuators.” Both individual RET actuators that drive a single mechanical linkage and “multi-RET actuators” that have a plurality of output members that drive a plurality or respective mechanical linkages are commonly used in base station antennas. In many instances, the multi-RET actuators that are currently available rely on rotatory sensors within the drive motors to determine positions of the sub-components within the actuator, which can be an expensive component.

### SUMMARY

A first aspect of the present invention is directed to a method of calibrating a multi-RET actuator system. The multi-RET actuator system includes a plurality of rotatable drive assemblies, each drive assembly operatively connected to a phase shifter assembly such that movement of the drive assembly adjusts the respective phase shifter assembly, a respective first connector coupled to each drive assembly, a drive system including a rotatable drive shaft, the drive shaft supporting a second connector, the drive system configured to transversely move along a drive screw relative to the drive assemblies, the second connector being releasably engageable with each respective first connector such that actuation of the drive system moves a selected drive assembly, and a movable sled assembly operatively connected to the drive system such that movement of the sled assembly engages or disengages the second connector with the first connector of the target drive assembly. The method includes retracting the sled assembly to partially disengage the second connector from the first connector of the selected drive assembly to determine a first known position of the second connector relative to the first connector of the selected drive assembly; retracting the sled assembly to completely disengage the second connector from the first connector of the selected drive assembly; actuating the drive system to rotate the drive screw such that the drive system transversely moves a number of rotations until the drive system contacts a stationary stop such that the second connector is in a second known position; and using the number of rotations of the drive screw to move the drive system from the first known position to the second known position as a stored position for the respective drive assembly.

In some embodiments, retracting the sled releases a counterforce on a spring within the respective first connector of the selected drive assembly which forces the second connector a distance from the selected drive assembly.

In some embodiments, the sled assembly is retracted a distance of about 3 mm to partially disengage the second connector from the first connector of the selected drive assembly.

In some embodiments, the method further includes storing the first known position in a memory of a base station control system or a control protocol stack.

In some embodiments, the first known position and the second known position are determined through communication with one or more integrated hall position sensors.

Another aspect of the present invention is directed to a method of operating a multi-RET actuator system. The multi-RET actuator system includes a plurality of rotatable drive assemblies, each drive assembly operatively connected to a phase shifter assembly such that rotation of the drive assembly adjusts the respective phase shifter assembly, a respective first connector coupled to each drive assembly, a drive system including a rotatable drive shaft, the drive shaft supporting a second connector, the drive system configured to transversely move along a drive screw relative to the drive assemblies, the second connector being releasably engageable with each respective first connector such that actuation of the drive system moves a target drive assembly, and a movable sled assembly operatively connected to the drive system such that movement of the sled assembly engages or disengages the second connector with the first connector of the target drive assembly. The method includes positioning the drive system adjacent to the target drive assembly; extending the sled assembly to engage the second connector of the drive system with the first connector of the target drive assembly; retracting the sled assembly and actuating the drive system to rotate the drive shaft and second connector if the second connector does not also completely engage with the first connector of the target drive assembly; extending the sled assembly to completely engage the second connector of the drive system with the first connector of the target drive assembly; and actuating the drive system to adjust the phase shifter assembly coupled to the target drive assembly.

In some embodiments, the step of positioning the drive system adjacent to the target drive assembly includes actuating a drive motor to transversely move the drive system relative to the target drive assembly to a stored position of the target drive assembly.

In some embodiments, the first connector of the target drive assembly and the second connector each include corresponding engagement structures that are configured to engage when the sled assembly is extended to engage the second connector with the first connector of the target drive assembly.

In some embodiments, a misalignment of the second connector and the first connector of the target drive assembly is detected when the engagement structures of the second connector do not completely engage with the engagement structures of the first connector of the target drive assembly.

In some embodiments, the method further includes measuring power used by a sled motor to extend the sled to engage the second connector with the first connector of the target drive assembly such that a misalignment is detected if the power exceeds a predetermined power threshold.

In some embodiments, the step of actuating the drive system to rotate the drive shaft and second connector includes rotating the drive shaft a half rotation of a respective engagement structure of the second connector.

In some embodiments, the method further includes retracting the sled assembly to partially disengage the second connector from the first connector of the target drive assembly to determine a first known position of the second connector relative to the first connector of the target drive assembly; retracting the sled assembly to completely disengage the second connector from the first connector of the target drive assembly; actuating the drive system to rotate the drive screw such that the drive system transversely moves a number of rotations until the drive system contacts a stationary stop such that the second connector is in a second known position; and using the number of rotations of the drive screw to move the drive system from the first known position to the second known position as a stored position for the target drive assembly.

In some embodiments, retracting the sled releases a counterforce on a spring within the first connector of the target drive assembly which forces the second connector a distance from the target drive assembly.

In some embodiments, the sled assembly is retracted a distance of about 3 mm to partially disengage the second connector from the first connector of the target drive assembly.

In some embodiments, the method further includes storing the first known position in a memory of a base station control system or a control protocol stack.

In some embodiments, the first known position and the second known position are determined through communication with one or more integrated hall position sensors.

In some embodiments, the step of actuating the drive system includes rotating a lead screw to move a drive nut along the lead screw wherein the drive nut is operatively connected to the phase shifter assembly.

In some embodiments, the drive system is actuated until a target electrical tilt for the corresponding phase shifter assembly is reached.

In some embodiments, the method further includes storing a physical position of the drive nut in a memory of the base station control system and/or control protocol stack.

Another aspect of the present invention is directed to a multi-RET actuator system. The system includes a plurality of drive assemblies, each drive assembly operatively connected to one or more phase shifter assemblies such that movement of one of the drive assemblies adjusts at least one of the one or more phase shifter assemblies; a plurality of first connectors, each first connector coupled to a respective one of the drive assemblies; a drive system including a drive screw and a drive shaft, the drive shaft supporting a second connector, the drive system coupled to and configured to transversely move along the drive screw to position the drive system adjacent to a target drive assembly of the plurality of drive assemblies, the second connector being releasably engageable with each of the respective first connectors; a first motor, and a mode selection system including a movable sled assembly operatively connected to the drive system, the movable sled assembly configured to move the drive system between a first position and a second position such that movement of the sled assembly selectively engages or disengages the second connector with a respective first connector for the target drive assembly. When in the first position, the second connector engages the respective first connector of the target drive assembly, and when in the second position, the second connector disengages the respective first connector of the target drive assembly such that the drive system can transversely move relative to the plurality of drive assemblies. When the second connector cannot engage in the first position with the respective first connector for the target drive assembly, the mode selection system is configured to retract the movable sled assembly and actuate the drive system to rotate the drive shaft and second connector relative to the respective first connector for the target drive assembly.

In some embodiments, the multi-RET actuator system further includes a second motor.

In some embodiments, the multi-RET actuator system further includes one or more integrated hall position sensors.

In some embodiments, the multi-RET actuator system further includes a removable control cartridge.

In some embodiments, the removable control cartridge contains the first motor, the second motor, and the one or more integrated hall position sensors.

In some embodiments, the first motor is configured to actuate the drive system and the second motor is configured to actuate the sled assembly.

In some embodiments, actuation of the drive system selectively rotates the target drive assembly when the second connector is engaged with the respective first connector.

In some embodiments, the multi-RET actuator system further includes a base station control system in communication comprising a processor and a memory for storing a known position of the drive system.

In some embodiments, each drive assembly comprises a lead screw and a drive nut threadably engaged with the lead screw, the drive nut being operatively connected to the corresponding phase shifter assembly.

In some embodiments, the second connector is engageable with a respective first connector of the target drive assembly by a linear movement of the drive system relative to the target drive assembly.

In some embodiments, each of the first connectors comprise a coupling member mounted on an end of the respective drive assembly for reciprocating motion relative thereto, the coupling member rotating with the respective drive assembly.

In some embodiments, each of the first connectors further include a spring that exerts a force on the coupling member that biases the coupling member toward the second connector.

In some embodiments, the coupling member includes a plurality of first engagement structures arranged about a rotational axis of each of the first connectors, and wherein the second connector includes a plurality of second engagement structures arranged about a rotational axis of the second connector configured to matingly engage the plurality of first engagement structures on the respective first connector of the target drive assembly.

In some embodiments, the drive system is supported for reciprocating movement transverse to the plurality of drive assemblies such that the drive system may be aligned with any one of the plurality of drive assemblies.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1A is a perspective view of an example base station antenna according to embodiments of the present invention.

FIG. 1B is a perspective view of the base station antenna of FIG. 1A with the radome thereof removed.

FIG. 2 is a schematic block diagram illustrating the electrical connections between various of the components of the base station antenna of FIGS. 1A-1B.

FIG. 3 is a schematic view of a multi-RET actuator of the present invention that may be included in the base station antenna of FIGS. 1A-1B.

FIGS. 4A-4B are top views of a multi-RET actuator of the present invention that may be included in the base station antenna of FIGS. 1A-1B.

FIG. 4C is an enlarged top view of the drive/index system of the multi-RET actuator of FIGS. 4A-4B according to embodiments of the present invention.

FIG. 4D is an enlarged perspective view illustrating the engagement of the drive adapter and the coupling member of the multi-RET actuator of FIGS. 4A-4B according to embodiments of the present invention.

FIG. 5 is a flowchart illustrating a method of performing calibration measurements for the multi-RET actuators of FIG. 3 and FIGS. 4A-4B, according to embodiments of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components, or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer, or section. Thus, a first element, component, region, layer, or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Modern base station antennas often include two, three or more linear arrays of radiating elements, where each linear array has an electronically adjustable down tilt. The linear arrays typically include cross-polarized radiating elements, and a separate phase shifter is provided for electronically adjusting the down tilt of the antenna beam for each polarization, so that the antenna may include, for example, twice as many phase shifters as linear arrays. Moreover, in many antennas, separate transmit and receive phase shifters are provided so that the transmit and receive radiation patterns may be independently adjusted. This again doubles the number of phase shifters. Thus, it is not uncommon for a base station antenna to have eight, twelve, sixteen or more phase shifters for applying remote electronic down tilts to the linear arrays. As described above, RET actuators are provided in the antenna that are used to adjust the phase shifters. While the same downtilt is typically applied to the phase shifters for the two different polarizations, allowing a single RET actuator and a single mechanical linkage to be used to adjust the phase shifters for both polarizations, modern base station antennas still often include four, six, eight or more RET actuators (or, alternatively, one or two multi-RET actuators) and associated mechanical linkages.

In order to change the downtilt angle of an antenna beam generated by a linear array on a base station antenna, a control signal may be transmitted from a base station control system to the antenna that causes a RET actuator associated with the linear array to generate a desired amount of movement in an output member thereof. The movement may comprise, for example, linear movement or rotational movement. A mechanical linkage is used to translate the movement of the output member of the RET actuator to movement of a moveable element of a phase shifter (e.g., a wiper arm) associated with the linear array. Accordingly, each mechanical linkage may extend between the output member of the RET actuator and the moveable element of the phase shifter.

Because the adjustment of the phase shifter requires precise movement, the accuracy of the RET actuator must be controlled in order to ensure that the downtilt angle of the antenna beam is correct. The repeated actuation of the RET actuator can result in inaccuracies being introduced into the system (e.g., mechanical slack). For example, a correct reference point (e.g., non-slack reference point) may be lost when mechanical subcomponents of the RET actuator are disengaged, previously known mechanical slack within the system may not be consistent when extending and retracting mechanical subcomponents of the RET actuator, and/or attempts to realign mechanical subcomponents of the RET actuator may create unwanted tension and flexing within the system.

Embodiments of the present invention provide a multi-RET actuator and a mechanical calibration system for a multi-RET actuator. Embodiments of the present invention further provide methods of detecting and correcting position misalignment of mechanical subcomponents within the multi-RET actuator. Embodiments of the present invention further provide methods of correcting and zeroing-out mechanical slack within the multi-RET actuator that may contribute to position inaccuracies within the system. Embodiments of the present invention further provide methods of calibrating the multi-RET actuator to recover any position drift of the mechanical subcomponents within the multi-RET actuator.

Embodiments of the present invention will now be discussed in greater detail with reference to the drawings. In some cases, two-part reference numerals are used in the drawings. Herein, elements having such two-part reference numerals may be referred to individually by their full reference numeral (e.g., linear array 120-2) and may be referred to collectively by the first part of their reference numerals (e.g., the linear arrays 120).

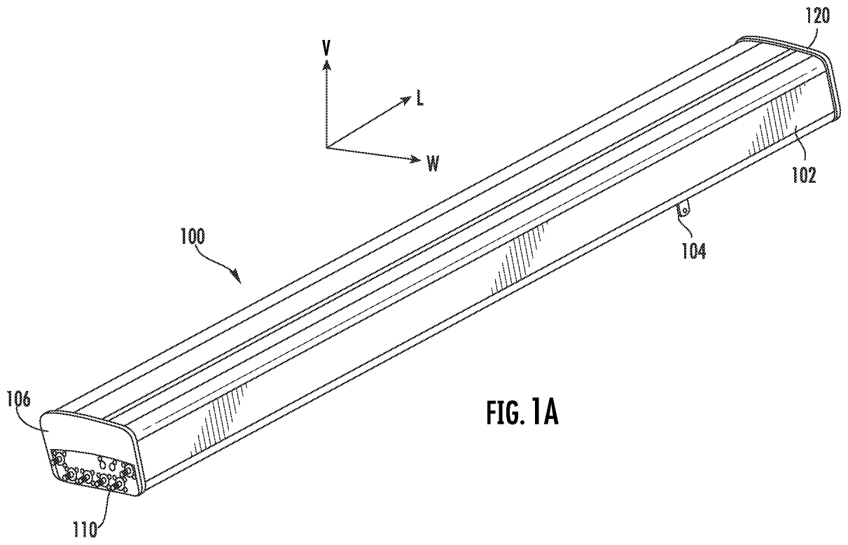

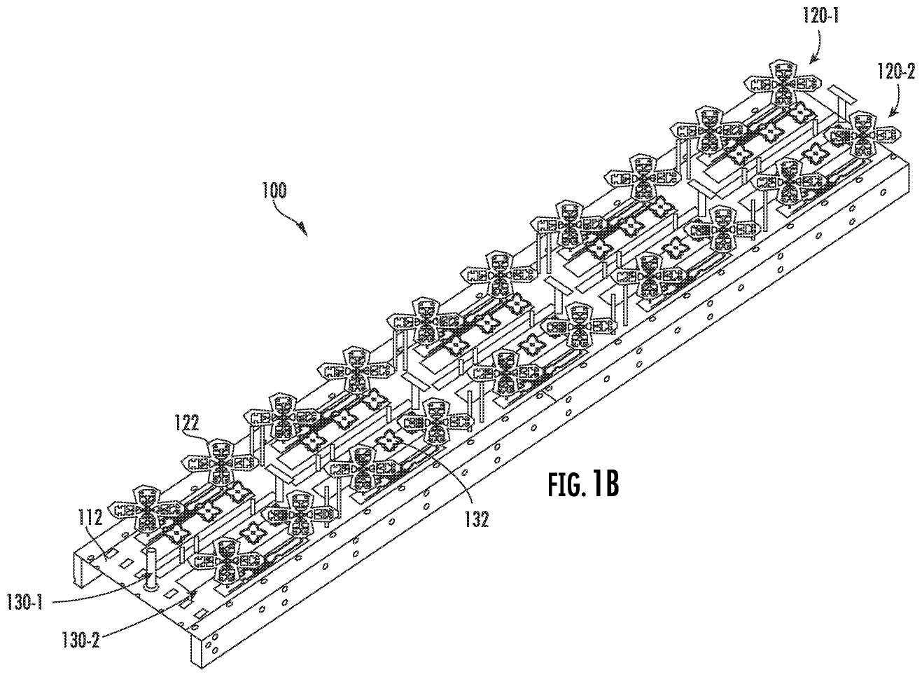

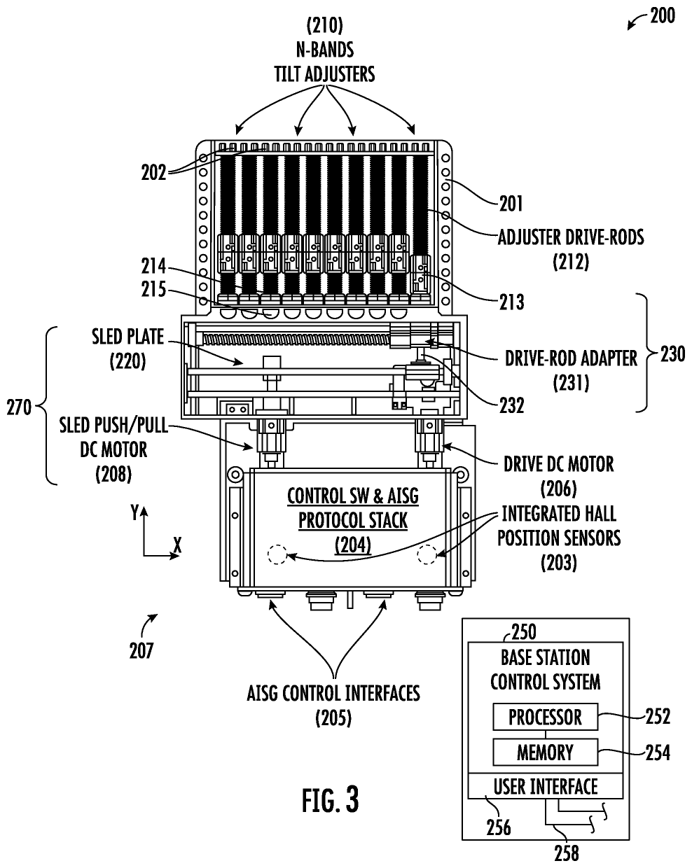

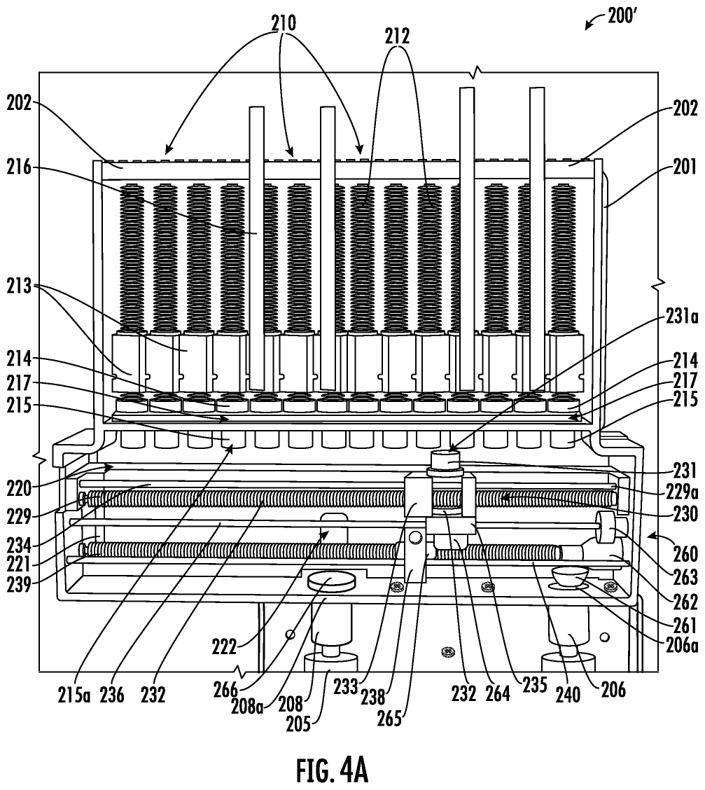

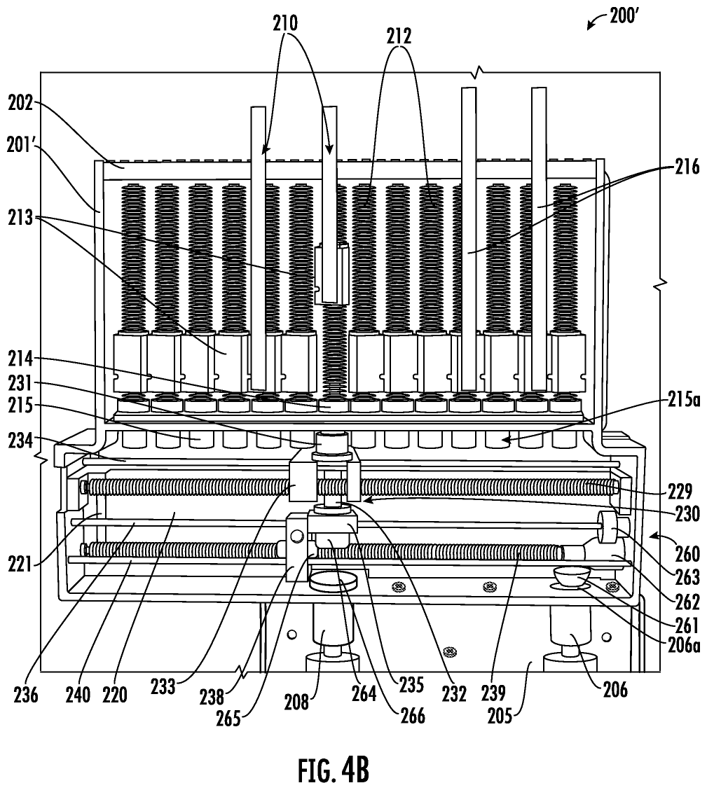

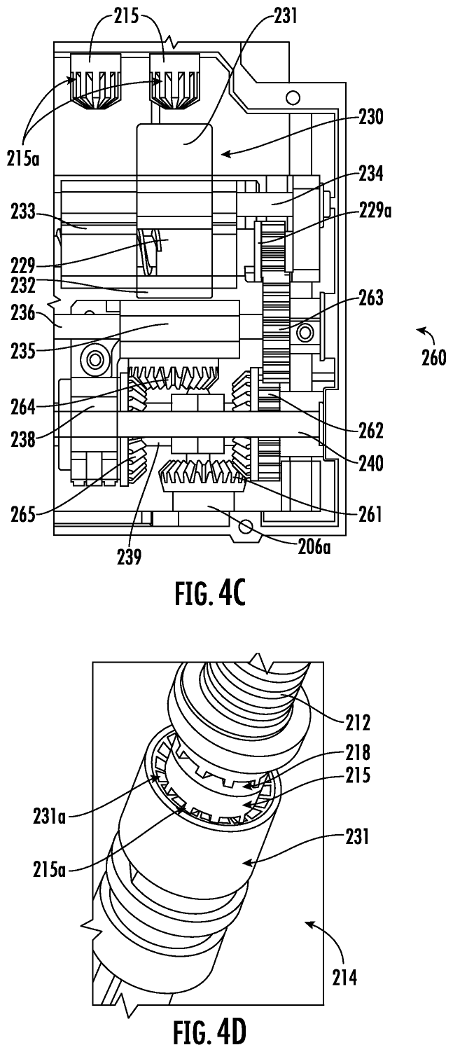

FIG. 1A is a perspective view of a RET base station antenna 100 according to embodiments of the present invention. FIG. 1B is a perspective view of the base station antenna 100 with the radome removed to show the four linear arrays of radiating elements that are included in antenna 100. While FIGS. 1A-1B illustrate a base station antenna that has four linear arrays, it will be appreciated that many modern base station antennas have much larger numbers of linear arrays. For example, many base station antennas now have six, eight, or ten linear arrays, or include multi-column arrays of radiating elements which have a pair of phase shifters for each column of the array. As shown in FIG. 3 and FIGS. 4A-4B, the RET actuator according to embodiments of the present invention may have relatively large numbers of outputs (e.g., 10 outputs as shown in FIGS. 3, and 14 outputs as shown in FIGS. 4A-4B) and thus, can drive relatively large numbers of phase shifters (e.g., 20 or 28).

As shown in FIG. 1A, the RET antenna 100 includes a radome 102, a mounting bracket 104, a bottom end cap 106 and a top end cap 120. A plurality of input/output ports 110 are mounted in the bottom end cap 106. Coaxial cables (not shown) may be connected between the input/output ports 110 and the RF ports on one or more radios (not shown). These coaxial cables may carry RF signals between the radios and the base station antenna 100. The input/output ports 110 may also include control ports that carry control signals to and from the base station antenna 100 from a base station control system (not shown) that may be located remotely from base station antenna 100. These control signals may include control signals for electronically changing the tilt angle of the antenna beams generated by the base station antenna 100.

For ease of reference, FIG. 1A includes a coordinate system that defines the length (L), width (T) and depth (V) axes (or directions) of the base station antenna 100 that will be discussed throughout the application. The length axis may also be referred to as the longitudinal axis.

FIG. 1B is a perspective view of the base station antenna of FIG. 1A with the radome 102 removed. As shown in FIG. 1B, the base station antenna 100 includes two linear arrays 120-1, 120-2 of low-band radiating elements 122 (i.e., radiating elements that transmit and receive signals in a lower frequency band) and two linear arrays 130-1, 130-2 of high-band radiating elements 132 (i.e., radiating elements that transmit and receive signals in a higher frequency band). Each of the low-band radiating elements 122 is implemented as a cross-polarized radiating element that includes a first dipole that is oriented at an angle of −45° with respect to the azimuth plane (a horizontal plane) and a second dipole that is oriented at an angle of +45° with respect to the azimuth plane. Similarly, each of the high-band radiating elements 132 is implemented as a cross-polarized radiating element that includes a first dipole that is oriented at an angle of −45° with respect to the azimuth plane and a second dipole that is oriented at an angle of +45° with respect to the azimuth plane. Since cross-polarized radiating elements are provided, each linear array 120-1, 120-2, 130-1, 130-2 will generate two antenna beams, namely a first antenna beam generated by the −45° dipoles and a second antenna beam generated by the +45° dipoles. The radiating elements 122, 132 extend forwardly from a backplane 112 which may comprise, for example, a sheet of metal that serves as a ground plane for the radiating elements 122, 132.

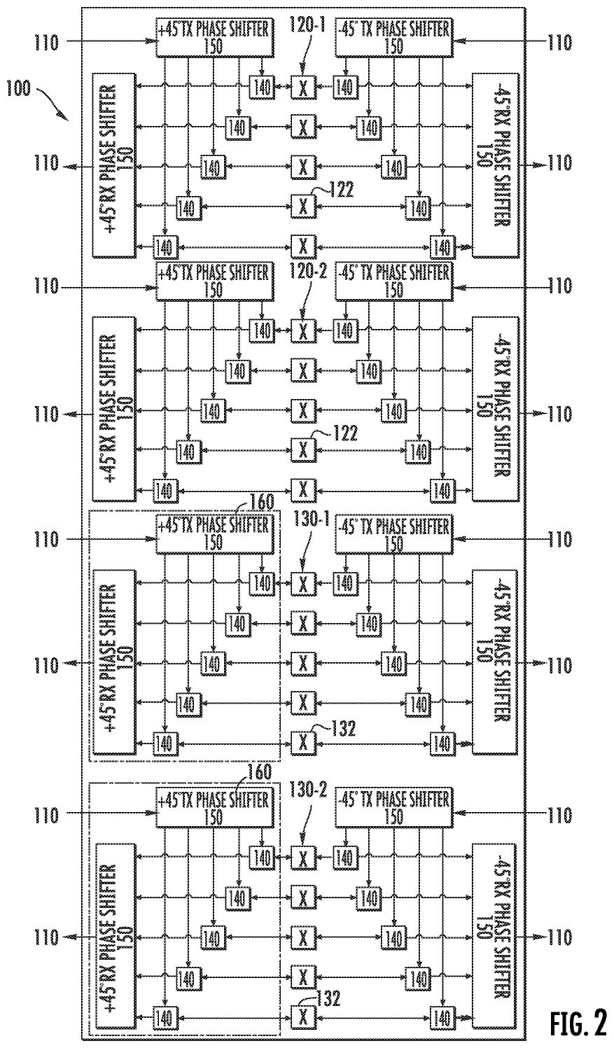

FIG. 2 is a schematic block diagram illustrating various additional components of the RET antenna 100 and the electrical connections therebetween. It should be noted that FIG. 2 does not show the actual location of the various elements on the antenna 100, but instead is drawn to merely show the electrical transmission paths between the various elements.

As shown in FIG. 2, each input/output port 110 may be connected to a phase shifter 150. The base station antenna 100 performs duplexing between the transmit and receive sub-bands for each linear array 120, 130 within the antenna (which allows different downtilts to be applied to the transmit and receive sub-bands), and hence each linear array 120, 130 includes both a transmit (input) port 110 and a receive (output) port 110. A first end of each transmit port 110 may be connected to the transmit port of a radio (not shown) such as a remote radio head. The other end of each transmit port 110 is coupled to a transmit phase shifter 150. Likewise, a first end of each receive port 110 may be connected to the receive port of a radio (not shown), and the other end of each receive port 110 is coupled to a receive phase shifter 150. Two transmit ports, two receive ports, two transmit phase shifters and to receive phase shifters are provided for each linear array 120, 130 to handle the two different polarizations.

Each transmit phase shifter 150 divides an RF signal input thereto into five sub-components, and applies a phase taper to these sub-components that sets the tilt (elevation) angle of the antenna beam generated by an associated linear array 120, 130 of radiating elements 122, 132. The five outputs of each transmit phase shifter 150 are coupled to five respective duplexers 140 that pass the sub-components of the RF signal output by the transmit phase shifter 150 to five respective sub-arrays of radiating elements 122, 132. In the example antenna 100 shown in FIG. 1A, FIG. 1B and FIG. 2, each low-band linear array 120 includes ten low-band radiating elements 122 that are grouped as five sub-arrays of two radiating elements 122 each. Each high-band linear array 130 includes fifteen high-band radiating elements 132 that are grouped as five sub-arrays of three radiating elements 132 each.

Each sub-array of radiating elements passes received RF signals to a respective one of the duplexers 140, which in turn route those received RF signals to the respective inputs of an associated receive phase shifter 150. The receive phase shifter 150 applies a phase progression to each received RF signal input thereto that sets the tilt angle for the receive antenna beam and then combines the received RF signals into a composite RF signal. The output of each receive phase shifter 150 is coupled to a respective receive port 110.

While FIG. 1B and FIG. 2 show an antenna having two linear arrays 120 of ten low-band radiating elements 122 each and two linear arrays 130 of fifteen high-band radiating elements 132 each, it will be appreciated that the number of linear arrays 120, 130 and the number of radiating elements 122, 132 included in each of the linear array 120, 130 may be varied. It will also be appreciated that duplexing may be done in the radios instead of in the antenna 100, that the number(s) of radiating elements 122, 132 per sub-array may be varied, that different types of radiating elements may be used (including single polarization radiating elements) and that numerous other changes may be made to the base station antenna 100 without departing from the scope of the present invention.

As can be seen from FIG. 2, the base station antenna 100 may include a total of sixteen phase shifters 150. While the two transmit phase shifters 150 for each linear array 120, 130 (i.e., one transmit phase shifter 150 for each polarization) may not need to be controlled independently (and the same is true with respect to the two receive phase shifters 150 for each linear array 120, 130), there still are eight sets of two phase shifters 150 that should be independently controllable. Accordingly, eight mechanical linkages may be required to connect the eight sets of phase shifters 150 to respective RET actuators.

Each phase shifter 150 shown in FIG. 2 may be implemented, for example, as a rotating wiper phase shifter. The phase shifts imparted by a phase shifter 150 to each sub-component of an RF signal may be controlled by a mechanical positioning system that physically changes the position of the rotating wiper of each phase shifter 150. It will be appreciated that other types of phase shifters may be used instead of rotating wiper phase shifters such as, for example, trombone phase shifters, sliding dielectric phase shifters and the like.

Referring to FIG. 3 and FIGS. 4A-4D, multi-RET actuator systems 200, 200′ according to embodiments of the present invention are illustrated. Other exemplary RET actuators that may encompass embodiments of the present invention are described in PCT Publication No. WO2021/046149 to CommScope Technologies, LLC, the disclosure of which is hereby incorporated by reference in its entirety. The multi-RET actuator systems 200, 200′ are used to drive the moveable elements of the phase shifters 150. As shown in the figures, a housing 201, 201′ contains and supports the components of the multi-RET actuator system where multiple outputs are provided that can drive multiple respective mechanical linkages. The housing 201, 201′ may be an enclosed, opaque housing and may be made of a suitable rigid material, such as plastic, metal or combinations of materials.

As shown in FIG. 3, in some embodiments, a base station control system 250 may control operation of the antenna 100 as is known in the art. The base station control system 250 may also control the multi-RET actuator system 200, 200′ as will hereinafter be described. Communications cables 258 may be used to deliver control signals from the base station control system 250 to the multi-RET actuator 200, 200′ and from the multi-RET actuator 200, 200′ to the base station control system 250.

In some embodiments, a control software protocol stack 204 may also be utilized to monitor and control the operation of the multi-RET actuator system 200, 200′. The control software protocol stack 204 may be in communication with the base station control system 250.

In some embodiments, the control software protocol stack 204 may be provided in a cartridge 207 that is releasably engageable with the multi-RET actuator system 200, 201′ (i.e., removable). In some embodiments, the cartridge 207 may also comprise one or more direct current (DC) motors (i.e., motors 206, 208) that are configured to actuate one or more of the components of the multi-RET actuator system 200, 200′, as will be described in further detail below.

In some embodiments, the base station control system 250 may comprise a processor 252 communicably coupled to such devices as a memory 254 and a user interface 256. The processor 252 generally includes circuitry for implementing communication and/or logic functions of the antenna. The processor 252 may include functionality to operate one or more software programs, which may be stored in the memory 254. The base station control system 250 may be located remotely from the antenna 100, may be collocated with the antenna 100 or various functions of the base station control system 250 may be allocated between the antenna and a remote location.

As used herein, a “processor” refers to a device or combination of devices having circuitry used for implementing the communication and/or logic functions of the system. For example, the processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in memory 254. As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory” generally refers to a device or combination of devices that store one or more forms of computer-readable media for storing data and/or computer-executable program code/instructions. For example, in one embodiment, the memory 254 as described herein includes any computer memory that provides an actual or virtual space to temporarily or permanently store data and/or commands provided to the processor 252 when the processor carries out its functions described herein. As used herein, “memory” includes any computer readable medium configured to store data, code, or other information. The memory may include volatile memory, such as volatile Random Access Memory (RAM) including a cache area for the temporary storage of data. The memory may also include non-volatile memory, which can be embedded and/or may be removable. The non-volatile memory can additionally or alternatively include an electrically erasable programmable read-only memory (EEPROM), flash memory or the like.

The user interface 256 may be made up of user output devices and/or user input devices, which are operatively coupled to the processor 252. The user output devices may include a visual display, audio device and/or the like. The user input devices may include any of a number of devices allowing the base station control system 250 to receive data, such as a keypad, keyboard, touch-screen, touchpad, microphone, mouse, joystick, other pointer device, button, soft key, and/or other input device(s).

A multi-RET actuator 200 having ten (10) drive assemblies (or tilt adjusters) 210 is shown in FIG. 3. The drive assemblies 210 may move ten or more mechanical linkages 216 where each drive assembly 210 is operatively connected to at least one phase shifter assembly by a mechanical linkage 216. While ten drive assemblies 210 are shown, the multi-RET actuator 200 is scalable such that the multi-RET actuator 200 may include a greater or fewer number of drive assemblies 210 to move a greater or fewer number of mechanical linkages 216. For example, as shown in FIGS. 4A-4B, the multi-RET actuator 200′ has fourteen (14) drive assemblies 210 which may move fourteen or more mechanical linkages 216 where each drive assembly 210 is operatively connected to at least one phase shifter assembly by a mechanical linkage 216.

The drive assemblies 210 each comprise a drive mechanism for converting a rotational input into a linear output. In one embodiment, the drive assemblies 210 comprise a rotary drive member that is operatively connected to a linear output. The linear output is operatively coupled to a phase shifter assembly by the mechanical linkage 216 such that movement of the linear output adjusts the phase shifter assembly. The drive assemblies 210 are identical such that a single drive assembly 210 will be described in detail. In one embodiment, the drive assembly 210 comprises an adjuster drive rod (e.g., a lead screw) 212 that is rotatably supported in the housing 201, 201′ such that the lead screw 212 is rotatable along its longitudinal axis (i.e., along the Y-axis as illustrated in FIG. 3). The drive assembly 210 may also comprise a belt drive, chain drive, ball drive, gear train, linkage, or the like, or combinations of such devices.

The distal end of the lead screw 212 may be supported in a suitable bearing 202 in a wall of the housing 201, 201′. The proximal end of lead screw 212 includes a screw connector 214 that is mounted to the lead screw 212 for rotation therewith. The screw connector 214 comprises a coupling member 215 that is rotationally supported in and extends through an aperture in a wall of the housing 201. The lead screws 212 of the drive assemblies 210 may be disposed parallel to one another.

A linear output is provided for transmitting the rotation of the drive assemblies 210 to the mechanical linkage 216. In one embodiment, the linear output comprises a drive nut 213 that threadably engages the lead screw 212 so that rotation of the lead screw 212 causes the drive nut 213 to reciprocate along the length of the lead screw 212. The drive nut 213 includes a connection mechanism for connecting the drive nut 213 to the mechanical linkage 216. Any suitable connection mechanism may be used to connect the drive nut 213 to the mechanical linkage 216. The direction of rotation of the lead screw 212 may be reversed to change the direction of travel of the drive nut 213 along the lead screw 212. The mechanical linkage 216 that connects to the phase shifter assembly is connected to the drive nut 213 such that the reciprocating movement of the drive nut 213 causes the adjustment of the phase shifter assembly as previously described.

The screw connector 214 releasably connects the lead screw 212 to a drive rod adapter (or drive adapter) 231 of a drive system 230. The screw connector 214 is configured such that the drive adapter 231 may be selectively connected to, and released from, the screw connector 214 by a linear movement of the drive adapter 231 relative to the screw connector 214 along the rotational axis of the lead screw 212. The screw connector 214 also functions to lock the drive assemblies 210 in position during use of the multi-RET actuators 200, 201′, as will be described.

The coupling member 215 of the screw connector 214 is mounted on the end of the lead screw 212 for reciprocating motion relative thereto along the longitudinal axis of the lead screw 212 (i.e., along the Y-axis as shown in FIG. 3). In some embodiments, the proximal end of the lead screw 212 and the coupling member 215 are provided with a series of flat faces, such as a hex-style connector, that allows reciprocating motion between the coupling member 215 and the lead screw 212, but that prevents relative rotational movement therebetween. Other mating mechanisms may be used between the coupling member 215 and the lead screw 212 such as a keyed connection, pin and slot arrangement, or the like. A spring 217 exerts a force on the coupling member 215 that tends to move the coupling member 215 away from the lead screw 212 toward the drive adapter 231. The spring 217 may comprise a compression spring that is located in a longitudinally extending recess formed in the end of the lead screw 212.

The coupling member 215 includes a series of engagement structures 215a that are arranged in spaced relationship about the rotational axis of the coupling member 215 (see also, e.g., FIG. 4D). The engagement structures 215a may comprise a series of external teeth, flat surfaces, splines, a star receptacle or the like that matingly and releasably engage with corresponding engagement structures 231a formed on the drive adapter 231 and that transfer rotary movement of the drive adapter 231 to the lead screw 212 (see also, e.g., FIG. 4D). In some embodiments, the engagement structures 215a may comprise a plurality of equally spaced teeth, but any suitable engagement structures that provide a releasable rotating connector to the drive adapter 231 may be used provided that the engagement structures allow for angular positioning of the lead screw 212 relative to the drive system 230, as will hereinafter be described. In this regard, the engagement structures 215a comprise a plurality of discrete elements arranged in known angular positions around the rotational axis of the lead screw 212.

The coupling member 215 may comprise a series of spaced locking members (or ribs) 218 arranged in an annular configuration about the longitudinal axis of the coupling member 215 (see, e.g., FIG. 4D). The locking members 218 of the coupling member 215 are configured to inter-engage with corresponding locking members (not shown) on the adjacent wall of the housing 201, 201′ to fix the lead screw 212 in position when the lead screw 212 is not being adjusted and is in the rest position. Absent a counteracting force, the spring 217 within the screw connector 214 extends the coupling member 215 away from the lead screw 212 such that the locking members of the coupling member 215 and wall of the housing 201, 201′ engage, thereby preventing the coupling member 215 from rotating. The keyed engagement of the coupling member 215 with the lead screw 212 prevents the lead screw 212 from rotating relative to the coupling member 215, and thus, locks the drive nut 213 in position as well as the position of the mechanical linkage 216 and the corresponding phase shifter assembly.

The drive/index mechanism of the multi-RET actuator system 200, 200′ will now be described. The drive/index mechanism comprises a drive system 230 that rotates a selected one of the lead screws 212 to adjust the position of the associated phase shifter assemblies and an index system 260 comprising a plurality of gears (e.g., gears 261, 262, 263, 264) that engage with each other and are coupled to the drive motor 206. The index system 260 is configured to change the position of the drive system 230 relative to the lead screws 212 of the drive assemblies 210, as described further herein. The drive system 230 comprises a drive shaft 232 that is rotated along its longitudinal axis (i.e., along Y-axis as shown in FIG. 3). The drive adapter 231 is supported at one end of the drive shaft 232 such that the drive adapter 231 rotates with the drive shaft 232. The screw connector 214, the coupling member 215, and drive adapter 231 are configured such that, when they are engaged with one another in the drive mode, the rotation of the drive shaft 232 is transferred to the selected lead screw 212.

In some embodiments, the drive adapter 231 comprises a generally socket-shaped member that receives the coupling member 215 of the screw connector 214. The socket member includes a plurality of engagement structures 231a that matingly engage with a plurality of corresponding engagement structures 215a formed on the coupling member 215 and that transfer rotary movement of the drive shaft 232 to the lead screw 212. The corresponding engagement structures 215a, 231a of the coupling member 215 and drive adapter 231 may be formed as a series of internal flats, splines, teeth, star connector or the like. Any suitable engagement structure that provides a releasable rotating connection and that allows the coupling member 215 and drive adapter 231 to be connected using a relative linear movement between the coupling member 215 and drive adapter 231 may be used provided that the engagement structures 215a, 231a allow for angular positioning of the drive adapter 231 relative to the coupling member 215 as will hereinafter be described. In this regard, an engagement structure 231a that comprises a plurality of discrete elements arranged in known angular positions around the rotational axis of the drive shaft 232 may be used. For example, a series of equally spaced teeth may be used. Energization of the drive motor 206 rotates one or more of the series of gears 261, 262, 263, 264 to thereby rotate the drive shaft 232 and drive adapter 231 (see, e.g., FIGS. 4A-4C).

As shown in FIGS. 4A-4C, the drive system 230 further comprises a first bearing block 233 that is supported on a first drive screw 229 and a first support rod 234. Both the first drive screw 229 and first support rod 234 allow the bearing block 233 to reciprocate transversely relative to lead screws 212 of the drive assemblies 210 such that the drive shaft 232 may be aligned with any one of the lead screws 212. The first bearing block 233 engages the first drive screw 229 such that as the first drive screw 229 rotates, the first bearing block 233 transverses along the first drive screw 229 relative to the lead screws 212 while sliding along the first rod 234 which provides support to the first bearing block 233 and drive system 230.

The drive system 230 also comprises a second bearing block 235 that is supported on a second support rod 236. The second bearing block 235 and second support rod 236 also allow the bearing block 235 to reciprocate transversely relative to the lead screws 212. The second bearing block 235 supports a gear 264 that is coupled to the drive shaft 232 of the drive system 230.

The drive system 230 also comprises a third bearing block 238 that is supported on a drive shaft 239 and a third support rod 240. The drive shaft 239 and third support rod 240 allow the third bearing block 238 to slide freely relative to the lead screws 212 of the drive assemblies 210. The third bearing block 238 also supports a gear 265 that is engaged with the gear 264 of the second bearing block 235.

The drive system 230 may be indexed by the index system 260. The index system 260 comprises a first gear 261 that is releasably affixed to the output shaft 206a of the drive motor 206 such that rotation of the output shaft 206a causes simultaneous rotation of the gear 261. The gear 261 is releasable from the output shaft 206a to allow the cartridge 207 containing the drive motor 206 to be removed from the multi-RET actuator system 200, 201′. A second gear 262 of the index system 460 is coupled to an end of the drive shaft 239 proximal to the drive motor 206. The second gear 262 is engaged with the first gear 261 and is configured to rotate the drive shaft 239. In some embodiments, the index system 260 comprises a third gear 263. The third gear 263 is engaged with the second gear 262 and the first drive screw 229. When engaged with the first drive screw 229, rotation of the output shaft 206a of the drive motor 206 causes simultaneous rotation of the gears 261, 262, 263, which in turn rotates the first drive screw 229. As a result, the first bearing block 235 (and drive system 230) reciprocate transversely along the first drive screw 229 relative to the lead screws 212 of the drive assemblies 210.

Information relating to the position of the drive system 230 (and drive adapter 231) relative to the drive assembly 210 is stored in the memory 254 of the base station control system 250. The base station control system 250 and/or control protocol stack 204 actuate the drive motor 206 over communication links to rotate the first drive screw 229 a predetermined angular rotational distance (number of rotations) and direction to position the drive system 230 opposite the selected one of the drive assemblies 210. In some embodiments, the base station control system 250 stores in memory 254 the current position of the drive system 230. The base station control system 250 also stores the direction and angular rotational distance of the motor 206 to move the drive system 230 from the current position to each of the positions aligned with the other drive assemblies 210.

When a phase shifter to be adjusted is selected at the base station control system 250, via user interface 256, for example, the base station control system 250 and/or control protocol stack 204 controls the drive motor 206 to rotate the first drive screw 229 a predetermined number of rotations in the proper direction (stored in memory 254) to move from the stored current position to the selected position. The new selected position is then stored in memory 254 as the current position. The indexing process may be repeated to move the drive system 230 to align with any of the drive assemblies 210.

In the drive mode, the drive system 230 is moved fully toward the lead screw 212 of the drive assembly 210 such that the coupling member 215 is engaged by the drive adapter 231 through movement of a sled 220, discussed further below. Rotation of the drive shaft 232 rotates the lead screw 212 to adjust the position of the phase shifter assembly operatively coupled to that lead screw 212. In the index mode, rotation of the first drive screw 229 indexes the drive system 230 transversely relative to the lead screws 212 to align the drive system 230 with a selected one of the lead screws 212 of the drive assemblies 210.

The drive system 230 may be further positioned by a mode selection system 270. The mode selection system 270 comprises a linearly reciprocating sled 220 that supports the drive system 230. Movement of the sled 220 reciprocates the drive system 230 between the index mode and the drive mode, described above. In some embodiments, the sled 220 comprises a generally planar platform that supports the drive system 230. The sled 220 is slidably supported on rods 221. The rods 221 extend parallel to the lead screws 212 such that the sled 220 and drive system 230 may be reciprocated linearly between the index mode and the drive mode as the sled 220 slides on the rods 221.

To effectuate movement of the sled 220, a drive shaft 222 is fixed to the platform that extends in the direction of travel of the sled 220, parallel to the rods 221 such that rotation of the drive shaft 222 causes the sled 220 to reciprocate linearly towards and away from the lead screws 212 of the drive assemblies 210. The drive shaft 222 engages a gear 266 that is releasably affixed to an output shaft 208a of the sled motor 208 such that rotation of the output shaft 208a causes simultaneous rotation of the gear 266 and drive shaft 222. In some embodiments, the sled motor 208 and output shaft 208a are fixed within the cartridge 207. Therefore, similar to gear 261, gear 266 is releasable from the output shaft 208a of the sled motor 208 to allow the cartridge 207 containing the sled motor 208 to be removed from the multi-RET actuator system 200, 201′.

Information relating to the relative position of sled 220 is stored in the memory 254 of the base station control system 250. The base station control system 250 and/or control protocol stack 204 actuates the sled motor 208 to rotate output shaft 222 a predetermined angular distance to position the drive system 230. The sled motor 208 may provide feedback to the base station control system 250 indicative of the sled 220 position over communication links. In other embodiments, the base station control system 250 saves in memory the current position of the sled 220 and the direction and angular rotation of the output shaft 222 to move the sled 220 such that when a new position is signaled, the base station control system 250 and/or control protocol stack 204 rotates the output shaft 222 the predetermined number of rotations in the proper direction to move from the saved current position to the selected position. The new selected position of the sled 220 is then saved as the current position (e.g., stored within memory 254).

As discussed above, in some embodiments, the drive motor 206 and sled motor 208 are integrated into a removable cartridge 207 (e.g., with Control Software & Antenna Interface Signal (AISG) protocol stack 204). In some embodiments, the cartridge 207 may comprise integrated hall position sensors 203 configured to determine the position of the drive system 230 and/or mode selection system 270 within the multi-RET actuator system 200, 200′. In some embodiments, the control protocol stack 204 also may allow the system to predict and/or correct the position of the components of the multi-RET actuator system 200, 200′ as described herein.

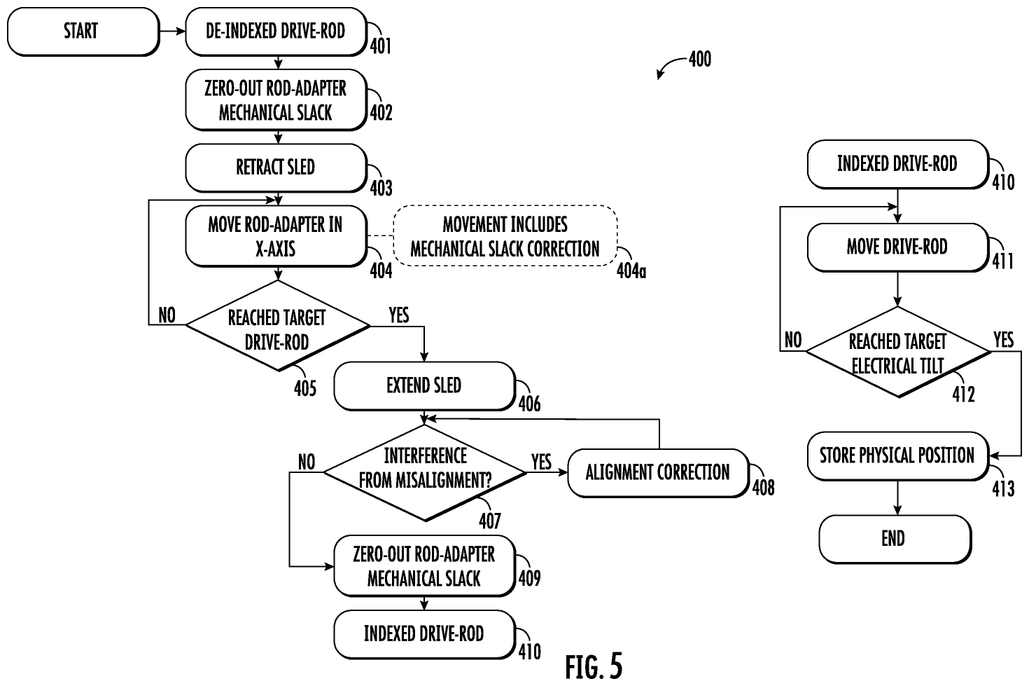

The operation of the multi-RET actuator system 200, 200′ to adjust a phase shifter according to embodiments of the present invention will be described and is shown in the flowchart illustrated in FIG. 5. It is to be understood that the system operates in a repetitive manner such that any position of the system may be considered the starting point and the system may move between the modes of operation based on control signals received from the base station control system 250 and/or the control protocol stack 204. As discussed above, the repeated actuation of the multi-RET actuator can result in inaccuracies being introduced into the system (e.g., mechanical slack). According to embodiments of the present invention, the multi-RET actuator system 200, 200′ allows for the detection and correction of position misalignment of the mechanical subcomponents within the multi-RET actuator which may include correcting and zeroing-out mechanical slack or calibrating the multi-RET actuator to recover position drift of the mechanical subcomponents.

The system can accurately couple a lead screw 212 of a drive assembly 210 to the drive motor 206 via the drive adapter 231 by placing the drive adapter 231 at a target location. This is achieved by coordinating the mechanical sled 220 and indexing movement using the drive motor 206 and the sled motor 208. In some embodiments, the drive motor 206 and/or the sled motor 208 are electric direct current (DC) motors. To adjust the position of a selected one of the phase shifter assemblies, the desired adjustment is received as an input by the user interface 256 of the base station control system 250 and/or through the AISG control interfaces 205 in communication with the control protocol stack 204. The input may include an identification of the selected phase shifter assembly and the adjustment level. The adjustment level may be input as an angle of change of a wiper printed circuit board or it may be input as a phase taper or using other data. The adjustment level is used by the base station control system 250 and/or control protocol stack 204 to identify the target drive assembly 210 to be adjusted and the amount and direction of rotation of the lead screw 212 that corresponds to the desired adjustment level.

The system operates to correct and zero-out (e.g., calibrate) any mechanical slack within the system that may be created by, for example, the plastic subcomponents of the multi-RET actuator system 200, 200′ which can contribute to position inaccuracies within the system. When an input signal or command is received to adjust the position of a phase shifter assembly (e.g., from the base station control system 250 or control protocol stack 204), the system first de-indexes the previously engaged lead screw 212 (i.e., drive assembly 210) for which the position of the corresponding phase shifter assembly was last adjusted [Block 401]. To de-index the lead screw 212, the sled 220 is retracted, as described herein, to disengage the drive adapter 231 from the coupling member 215 (i.e., lead screw 212). It is understood that when the drive adapter 231 was last engaged with the coupling member 215 of the lead screw 212, the series of corresponding engagement structures (e.g., teeth) 215a, 231a on the coupling member 215 and drive adapter 231 were properly mated.

To correct and zero-out any mechanical slack within the system along the longitudinal axis of the lead screw 212 (i.e., the Y-axis as shown in FIG. 3A), the sled 220 is retracted a distance of about 3 millimeters to partially disengage the drive adapter 231 from the coupling member 215 [Block 402]. Retracting the sled 220 releases the counterforce on the spring 217 within the screw connector 214 which pushes the coupling member 215 away from the lead screw 212. Using the spring 217 as a reference point, the correct mating position of the engagement structures 215a, 231a of the coupling member 215 and the drive adapter 231 (e.g., known position) is determined by the control protocol stack 204 with help from the integrated hall position sensors 203. As discussed herein, the coupling member 215 includes a fixed number of locking members or ribs 218 (see, e.g., FIG. 4D). For example, in some embodiments, the coupling member 215 includes twelve (12) ribs 218. When the sled 220 is retracted and the drive adapter 231 is partially disengaged from the coupling member (i.e., about 3 mm in longitudinal Y-axis direction), the force from the spring 217 pushes the ribs 218 of the coupling member 215 to align and sit within corresponding mating chamfers in the housing 201, which locks the lead screw 212 from rotating.

The control protocol stack 204 with the help from the integrated hall position sensors 203 rotates the drive adapter 231 until it detects mechanical interference or jam. In some embodiments, the drive adapter 231 is rotated in reverse to help avoid introducing unwanted tension and flexing in the subcomponents of the multi-RET actuator. This information is communicated back to the base station control system 250 where the base station control system 250 (e.g., processor 252) computes and zero-out the mechanical slack between drive adapter 231 and coupling member 215. Information relating to the relative position of the drive adapter 231 with respect to the coupling member 215 is also communicated and stored in the memory 254 of the base station control system 250.

The sled 220 is then fully retracted which completely disengages the drive adapter 231 from the coupling member 215 [Block 403]. In some embodiments, the fully retracted distance of the sled 220 is about 13 millimeters. Once the sled 220 is fully retracted and the drive adapter 231 disengaged from the coupling member 215, the drive system 230 is permitted to transversely move along drive screw 229 relative to the lead screws 212 [Block 404]. To complete the correction and zeroing-out of any mechanical slack within the system, the drive system 230 transversely moves along the drive screw 229 (i.e., toward index system 260) to an end of the drive screw 229 proximal to the drive motor 206 and/or until the drive system 230 contacts a stationary stop 229a at an end of the drive screw 229 (e.g., [Block 404a]. This movement along the drive screw 229 allows the system to learn (and store) the correct number of rotations of the drive screw 229 required to move the drive system 230 from the end of the drive screw 229 (or stationary stop 229a) into the correct position with respect to the drive assembly 210 (i.e., coupling member 215 and lead screw 212), thereby correcting and zeroing-out any mechanical slack currently within the system with respect to that particular drive assembly 210.

Next, the control protocol stack 204 (or base station system 250) controls the drive motor 206 to rotate the first drive screw 229 (via index system 260) a predetermined number of rotations (previously stored in memory 254) in the proper direction to move the drive system 230 to the selected/targeted lead screw 212 [Block 405]. As the drive system 230 transversely moves along the first drive screw 229, the system continuously checks the position of the drive system 230 via the integrated hall position sensors 203 in communication with the control protocol stack 204 and/or base station control system 250 to confirm that the phase shifter adjustment is being performed within the two minute industry standard for maximum movement time, such as described in 3^{rd} Generation Partnership Project (3GPP) Technical Specification TS-37.466 Release 15, Sections 6.6.3 and 6.7.2 and Antenna Interface Standards Group (AISG) Standard AISG v 2.0 (released 13 Jun. 2006).

The drive motor 206 continues to rotate the first drive screw 229 until the drive system 230 reaches the target lead screw 212 [Block 405]. The system is able to calculate the distance traveled by the drive system 230 along the first drive screw 229 based on the number of rotations of the first drive screw 229. For example, in some embodiments, the distance between each lead screw 212 is about 15 millimeters which is equivalent to n number of rotations of the drive screw 229.

Once the drive system 230 reaches the target lead screw 212, the sled motor 208 rotates output shaft 222 to extend the sled 220 toward the lead screw 212 as described herein. The sled 220 is extended until the drive adapter 231 engages the coupling member 215 for the targeted lead screw 212 (i.e., corresponding engagement structures 215a, 231a properly mate) [Block 406]. In some embodiments, the distance the sled 220 is extended is about 13 millimeters. The system checks for interference resulting from a misalignment between the drive adapter 231 and the coupling member 215 (i.e., misalignment of the engagement structures 231a, 215a on the drive adapter 231 and coupling member 215) [Block 407].

The control protocol stack 204 measures the amount of power being used by the sled motor 208 to move the sled 220 (i.e., extend the sled 220 along the Y-axis as shown in FIG. 3) to engage the drive adapter 231 with the coupling member 215 of the targeted drive assembly 210. The control protocol stack 204 moves the sled 220 a known distance (e.g., stored in memory 254) in the Y-axis free of mechanical interference using the sled motor 208. The movement speed of the sled 220 is kept constant with help from the integrated hall position sensors 203. From this first movement of the sled 220, the amount of power used to maintain a constant sled speed is used to detect any mechanical interference or obstructions when the drive adapter 231 and coupling member 215 engage on subsequent movements of the sled 220. A mechanical interference or obstruction is detected when a zero-speed is reported by the integrated hall position sensors 203 at the same output power (i.e., known power to maintain a constant sled speed). If the engagement structures 231a of the drive adapter 231 easily engage (mate) with the engagement structures 215a of the coupling member 215 within a predetermined range of power being used by the sled motor 208, then the system signals that there is no misalignment of the drive adapter 231 and coupling member 215, and thus no correction is needed. If, however, the integrated hall position sensors 203 detect an increase in power (i.e., exceeding a predetermined power threshold) being used by the sled motor 208 to move the sled 220 (i.e., extend the sled 220 along the Y-axis as shown in FIG. 3) and/or a zero sled speed (i.e., compared to the constant sled speed), then the system signals that the corresponding engagement structures 231a, 215a on the drive adapter 231 and coupling member 215 are misaligned, and an alignment correction is needed [Block 408].

To correct a misalignment of the drive adapter 231 and coupling member 215 (i.e., targeted drive assembly 210), the sled motor 208 retracts the sled 220 (via output shaft 222) to completely disengage the drive adapter 231 from the coupling member 215. The drive motor 206 then slightly rotates the drive shaft 232 of the drive system 230 to reposition the corresponding engagement structures 231a on the drive adapter 231 with respect to the target coupling member 215. For example, in some instances, the drive shaft 232 is rotated a half rotation of a respective engagement structure 231a of the drive adapter 231 to try and correct the misalignment with the corresponding engagement structure 215a of the target coupling member 215. In some embodiments, the drive adapter 231 is rotated in a reverse direction to avoid any over adjustment of the phase shifter assembly and/or to help avoid introducing tension and/or flexing into the mechanical subcomponents of the RET actuator.

The sled motor 208 then rotates the output shaft 222 to again extend the sled 220 back toward the coupling member 215 of the target lead screw 212 to make another attempt to fully engage the drive adapter 231 with the coupling member 215 [Block 406]. The system again checks for interference resulting from a misalignment between the drive adapter 231 and the coupling member 215 (i.e., misalignment of the engagement structures 231a on the drive adapter 231 and the engagement structures 215a on the coupling member 215 and/or exceeding the predetermined power threshold of the sled motor 208) [Block 407]. If the corresponding engagement structures 231a, 215a on the drive adapter 231 and the coupling member 215 easily engage (mate) with each other, then no further alignment correction is needed. If a misalignment is further detected, the same steps are repeated until interference is no longer detected or until the two minute industry standard for maximum movement time has been reached (e.g., 3GPP and AISG standards). Through precise control of the speed and position of the drive and sled motors 206, 208, the various mechanical subcomponents (e.g., drive adapter 231 and sled 220) of the multi-RET actuator system 200, 200′ are placed at the exact desired locations. The system 200, 200′ utilizes acceleration and deceleration profiles of the electric DC drive and sled motors 206, 208 to make system corrections and phase adjustments within the two minute industry time threshold.

After the drive adapter 231 is properly mated and engaged with the coupling member 215 of the target lead screw 212 (i.e., drive assembly 210), the system again corrects and zeros-out (i.e., calibrates) any mechanical slack within the system along the longitudinal axis of the lead screw 212 (i.e., along the Y-axis as shown in FIG. 3) [Block 409]. As previously described herein, the correct position of the coupling member 215 (i.e., lead screw 212) is communicated to the control protocol stack 204 with help from the integrated hall position sensors 203, using the spring 217 located within the screw connector 214 as a reference point. The sled 220 is then fully retracted which allows movement of the drive system 230 (and drive adapter 231) along first drive screw 229 [Block 404]. To complete the correction and zeroing-out of any mechanical slack within the system, the drive system 230 moves transversely along the first drive screw 229 relative to the lead screws 212 to an end of the first drive screw 229 proximal to the drive motor 206 (e.g., contacting stationary stop 229a) [Block 404a]. This transverse movement along the first drive screw 229 allows the system to learn (and store) the correct number of rotations required to move the drive system 230 from the end of the first drive screw 229 (e.g., from stationary stop 229a) to the correct position with respect to the last selected/targeted lead screw 212 and corresponding coupling member 215 that the drive adapter 231 was properly mated, thereby correcting and zeroing-out any mechanical slack currently within the system with respect to that particular drive assembly 210. After the mechanical slack is corrected and zeroed-out for the drive assembly 210, the position of the respective lead screw 212 has been indexed [Block 410].

After the position of the lead screw 212 has been indexed, the drive motor 206 rotates the first drive screw 229 to transversely move the drive system 230 back along the first drive screw 229 (i.e., along the X-axis as shown in FIG. 3). The drive motor 206 stops rotation of the first drive screw 229 when the drive system 230 (and drive adapter 231) reaches the target lead screw 212 (i.e., the lead screw 212 coupled to the phase shifter assembly to be adjusted). When the drive adapter 231 is in position, the sled motor 208 rotates the output shaft 222 to extend the sled 220 to engage the drive adapter 231 with the corresponding coupling member 215 of the target lead screw 212. Since the lead screw 212 has been correctly indexed, the drive adapter 231 should easily engage with the coupling member 215 (i.e., corresponding engagement structures 231a, 215a should properly mate). However, if a misalignment is detected, steps necessary to correct the misalignment as described herein are repeated. Once the drive adapter 231 is fully engaged with the coupling member 215, the sled motor 208 stops rotation of the output shaft 222 and the drive motor 206 rotates the drive adapter 231, which simultaneous rotates the coupling member 215 and corresponding lead screw 212 [Block 411].

As described herein, rotation of the lead screw 212 causes the drive nut 213 to reciprocate along the length of the lead screw 212 (i.e., along the Y-axis shown in FIG. 3). The mechanical linkage 216 that connects to the phase shifter assembly is connected to the drive nut 213 such that the reciprocating movement of the drive nut 213 causes the adjustment of the phase shifter assembly. The drive motor 206 continues to rotate the lead screw 212 until the target electrical tilt for the corresponding phase shifter assembly is reached [Block 412]. Once the target electrical tilt has been reached, the physical position of drive nut 213 is stored in the memory 254 of the base station control system 250 and/or control protocol stack 204 [Block 413].

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A method of calibrating a multi-RET actuator system, the multi-RET actuator system comprising a plurality of rotatable drive assemblies, each drive assembly operatively connected to a phase shifter assembly such that movement of the drive assembly adjusts the respective phase shifter assembly, a respective first connector coupled to each drive assembly, a drive system comprising a rotatable drive shaft, the drive shaft supporting a second connector, the drive system configured to transversely move along a drive screw relative to the drive assemblies, the second connector being releasably engageable with each respective first connector such that actuation of the drive system moves a selected drive assembly, and a movable sled assembly operatively connected to the drive system such that movement of the sled assembly engages or disengages the second connector with the first connector of the target drive assembly, the method comprising:
retracting the sled assembly to partially disengage the second connector from the first connector of the selected drive assembly to determine a first known position of the second connector relative to the first connector of the selected drive assembly;
retracting the sled assembly to completely disengage the second connector from the first connector of the selected drive assembly;
actuating the drive system to rotate the drive screw such that the drive system transversely moves a number of rotations until the drive system contacts a stationary stop such that the second connector is in a second known position; and
using the number of rotations of the drive screw to move the drive system from the first known position to the second known position as a stored position for the respective drive assembly.

2. The method according to claim 1, wherein retracting the sled releases a counterforce on a spring within the respective first connector of the selected drive assembly which forces the second connector a distance from the selected drive assembly.

3. (canceled)

4. The method according to claim 1, further comprising storing the first known position in a memory of a base station control system or a control protocol stack.

5. (canceled)

6. A method of operating a multi-RET actuator system, the multi-RET actuator system comprising a plurality of rotatable drive assemblies, each drive assembly operatively connected to a phase shifter assembly such that rotation of the drive assembly adjusts the respective phase shifter assembly, a respective first connector coupled to each drive assembly, a drive system comprising a rotatable drive shaft, the drive shaft supporting a second connector, the drive system configured to transversely move along a drive screw relative to the drive assemblies, the second connector being releasably engageable with each respective first connector such that actuation of the drive system moves a target drive assembly, and a movable sled assembly operatively connected to the drive system such that movement of the sled assembly engages or disengages the second connector with the first connector of the target drive assembly, the method comprising:
positioning the drive system adjacent to the target drive assembly;
extending the sled assembly to engage the second connector of the drive system with the first connector of the target drive assembly;
retracting the sled assembly and actuating the drive system to rotate the drive shaft and second connector if the second connector does not also completely engage with the first connector of the target drive assembly;
extending the sled assembly to completely engage the second connector of the drive system with the first connector of the target drive assembly; and
actuating the drive system to adjust the phase shifter assembly coupled to the target drive assembly.

7. The method according to claim 6, wherein the step of positioning the drive system adjacent to the target drive assembly comprises actuating a drive motor to transversely move the drive system relative to the target drive assembly to a stored position of the target drive assembly.

8.-11. (canceled)

12. The method according to claim 6, further comprising:
retracting the sled assembly to partially disengage the second connector from the first connector of the target drive assembly to determine a first known position of the second connector relative to the first connector of the target drive assembly;
retracting the sled assembly to completely disengage the second connector from the first connector of the target drive assembly;
actuating the drive system to rotate the drive screw such that the drive system transversely moves a number of rotations until the drive system contacts a stationary stop such that the second connector is in a second known position; and
using the number of rotations of the drive screw to move the drive system from the first known position to the second known position as a stored position for the target drive assembly.

13-16. (canceled)

17. The method according to claim 6, wherein the step of actuating the drive system comprises rotating a lead screw to move a drive nut along the lead screw wherein the drive nut is operatively connected to the phase shifter assembly.

18.-19. (canceled)

20. A multi-RET actuator system, the system comprising:
a plurality of drive assemblies, each drive assembly operatively connected to one or more phase shifter assemblies such that movement of one of the drive assemblies adjusts at least one of the one or more phase shifter assemblies;
a plurality of first connectors, each first connector coupled to a respective one of the drive assemblies;
a drive system comprising a drive screw and a drive shaft, the drive shaft supporting a second connector, the drive system coupled to and configured to transversely move along the drive screw to position the drive system adjacent to a target drive assembly of the plurality of drive assemblies, the second connector being releasably engageable with each of the respective first connectors;
a first motor; and
a mode selection system comprising a movable sled assembly operatively connected to the drive system, the movable sled assembly configured to move the drive system between a first position and a second position such that movement of the sled assembly selectively engages or disengages the second connector with a respective first connector for the target drive assembly, wherein in the first position the second connector engages the respective first connector of the target drive assembly, and in the second position the second connector disengages the respective first connector of the target drive assembly such that the drive system can transversely move relative to the plurality of drive assemblies,
wherein, when the second connector cannot engage in the first position with the respective first connector for the target drive assembly, the mode selection system is configured to retract the movable sled assembly and actuate the drive system to rotate the drive shaft and second connector relative to the respective first connector for the target drive assembly.

21. The multi-RET actuator system according to claim 20, further comprising a second motor.

22. The multi-RET actuator system according to claim 20, further comprising one or more integrated hall position sensors.

23. The multi-RET actuator system according to claim 20, further comprising a removable control cartridge.

24. The multi-RET actuator system according to claim 23, wherein the removable control cartridge contains the first motor, the second motor, and the one or more integrated hall position sensors.

25. The multi-RET actuator system according to claim 21, wherein the first motor is configured to actuate the drive system and the second motor is configured to actuate the sled assembly.

26. The multi-RET actuator system according to claim 20, wherein actuation of the drive system selectively rotates the target drive assembly when the second connector is engaged with the respective first connector.

27. The multi-RET actuator system according to claim 20, further comprising a base station control system comprising a processor and a memory for storing a known position of the drive system.

28. The multi-RET actuator system according to claim 20, wherein each drive assembly comprises a lead screw and a drive nut threadably engaged with the lead screw, the drive nut being operatively connected to the corresponding phase shifter assembly.

29. The multi-RET actuator system according to claim 20, wherein the second connector is engageable with a respective first connector of the target drive assembly by a linear movement of the drive system relative to the target drive assembly.

30. The multi-RET actuator system according to claim 20, wherein each of the first connectors comprise a coupling member mounted on an end of the respective drive assembly for reciprocating motion relative thereto, the coupling member rotating with the respective drive assembly.

31. (canceled)

32. The multi-RET actuator system according to claim 30, wherein the coupling member comprises a plurality of first engagement structures arranged about a rotational axis of each of the first connectors, and wherein the second connector comprises a plurality of second engagement structures arranged about a rotational axis of the second connector configured to matingly engage the plurality of first engagement structures on the respective first connector of the target drive assembly.

33. The multi-RET actuator system according to claim 20, wherein the drive system is supported for reciprocating movement transverse to the plurality of drive assemblies such that the drive system may be aligned with any one of the plurality of drive assemblies.
